(19) United States
(12) Patent Application Publication
(10) Pub. No.: US 2022/0128514 A1
(43) Pub. Date: Apr. 28, 2022

(54) WOOD BORING INSECT DETECTION SYSTEM AND METHOD

(71) Applicant: THE TRUSTEES OF THE STEVENS INSTITUTE OF TECHNOLOGY, Hoboken, NJ (US)

(72) Inventors: Hady SALLOUM, Cedar Grove, NJ (US); Alexander SEDUNOV, Jersey City, NJ (US); Nikolay Sedunov, Jersey City, NJ (US); Alexander SUTIN, Summit, NJ (US); Alexander Yakubovskiy, Providence, RI (US)

(73) Assignee: THE TRUSTEES OF THE STEVENS INSTITUTE OF TECHNOLOGY, Hoboken, NJ (US)

(21) Appl. No.: 17/429,925

(22) PCT Filed: Feb. 11, 2020
(86) PCT No.: PCT/US2020/017792

§ 371 Date: Aug. 10, 2021

Related U.S. Application Data
(60) Provisional application No. 62/804,129, filed on Feb. 11, 2019.

(51) Int. Cl. G01N 29/14; G01H 11/08; G01H 9/00; G01N 29/24; G01N 29/32; G01N 29/44

(52) U.S. Cl. CPC G01N 29/14; G01H 11/08; G01H 9/004; G01N 29/2418; G01N 2291/0238; G01N 29/32; G01N 29/4436; G01N 29/4454; G01N 29/4463; G01N 29/2437

(57) ABSTRACT

Embodiments of the invention include a system and method for detecting wood-boring species of insects in a structure (16), involving one or more primary (14) and reference (18) sensors and a signal conditioning and acquisition device (22) capable of being coupled to the sensors (14, 18). The system (10) also includes a processor (24) capable of being coupled to a non-transitory, computer-readable storage medium that includes program logic for execution by the processor (24). The program logic includes a logic module that receives signals originating from the sensors (14, 18) and discriminates between noise generated by any wood boring species in the structure and extraneous noise unrelated to the wood boring species of insects. The extraction of signal features based on pulse duration, signal spectra and signal envelope spectra can be used for insect pulse discrimination. A sound-suppressing sensor assembly (12) can be weighted to enhance the coupling of the primary sensor (14) with the structure (16) being tested.

### RELATED APPLICATIONS

This application claims priority to U.S. Provisional Application Ser. No. 62/804,129, filed on Feb. 11, 2019, the entire contents of which are incorporated herein by reference.

### STATEMENT REGARDING FEDERALLY SPONSORED RESEARCH OR DEVELOPMENT

This invention was made with government support under Grant No. HSHQDC-13-J-00133 awarded by the U.S. Department of Homeland Security's Science and Technology Directorate. This invention was also made with government support from the U.S. Department of Agriculture, Animal and Plant Health Inspection Service. The government has certain rights in the invention.

### FIELD OF THE INVENTION

The present invention relates to the detection of deleterious insects. More specifically, it relates to automated detection of insect-generated vibro-acoustic signals, and processing methods and systems for detecting the presence of unwanted wood boring insects in wood packing material, trees and the like, by acoustic and vibrational means.

### BACKGROUND OF THE INVENTION

It is estimated that exotic invasive species cost the American economy over $138 billion per year. The United States Department of Homeland Security Customs and Border Protection (CBP) facilitates yearly processing of about $2 trillion in legitimate trade, both imports and exports, while enforcing United States trade laws that protect the economy, health, and safety of people worldwide. Currently, CBP agriculture specialists rely mostly on manual techniques to inspect shipments. These methods are time-consuming and are generally not 100% effective, as available personnel resources typically allow for less than 2% of cargo to be examined. Wood boring pests are especially difficult and time-consuming to detect, as they burrow and feed inside the wood, and often leave few or no visual cues to their presence. Particularly destructive wood boring pests include the Asian longhorn beetle (i.e., Anoplophora glabripennis (Motchulsky), “ALB”) and the emerald ash borer (i.e., Agrilus planipennis Fairmaire, “EAB”).

Insect borers can produce significant damage to a wide range of agricultural, ornamental, landscape, and forest trees that have a significant impact on the US economy. In many publications it was stated that EAB is the most destructive and economically costly forest insect to ever invade North America. Simulations predict an expanding EAB infestation that will likely encompass most of the 25 affected states and warrant treatment, removal, and replacement of more than 17 million ash trees with a mean discounted cost of $10.7 billion.

Currently, the inspection of host trees within infested areas is conducted individually for signs of attack (e.g., oviposition pits and emergence holes) by using binoculars, hydraulic lifts and tree climbers. These approaches are time-consuming and expensive. Destructive sampling of plants has become necessary because visual inspections led to false negative decisions on several occasions, and therefore infested plants were released. However, destructive sampling is not ideal as it is costly to the importer and time-consuming for the inspector. Effective non-destructive techniques could ensure that the inspection process remains as effective while providing significant efficiencies to both the inspectors and the importers.

The development of vibro-acoustic detection methods for wood boring insects started decades ago. For example, vibro-acoustic/vibrational methods of detecting termites and other wood boring larvae have been investigated over the last three decades. However, reliable commercial products that can be used for inspections at United States ports of entry and trees require automated signal processing that can discriminate between larva-induced sound/vibration and sound/vibration resulting from background noise. Background noise contains many unwanted signals: sounds and vibration of machinery, noise and vibration from equipment (conditions, refrigerators, fans . . . etc.), human speech, etc. Currently, commercially available devices for detection of adult wood boring insects (e.g., such as termites) are available, e.g., the AED-2010 (from Acoustic Emission Consulting, Fair Oaks, Calif.). These systems can detect all types of sounds and vibrations; however, the separation of insect sounds and vibrations from ambient noise needs to be performed manually by a trained listener.

Accordingly, there exists a need for a sensor system that can be used in commercial and forest environments that detects the presence of wood boring insects in wood packing materials and trees.

### SUMMARY OF THE INVENTION

The present invention involves a system and method for detecting pulses potentially belonging to wood-boring pests, such as insect larvae, within a structure (e.g., wood product) while separating the pulses from external noise. In an embodiment, the system has a multi-component design, one component of which is a sensor assembly adapted to be positioned on a structure to be tested for insect infestation. In an embodiment, the sensor assembly includes a primary sensor adapted for placement in contact with the structure and functioning to sense (i.e., detect) vibro-acoustic signals emanating internally and/or externally of the structure, and a reference sensor adapted for placement near, but out of contact with, the structure and functioning to sense (i.e., detect) acoustic noise signals emanating externally of the structure. Each of the sensors (i.e., the primary sensor and the reference sensor) can provide a respective electric signal to a signal conditioning unit, which amplifies the electric signals and, in turn, transmits the amplified electric signals to a data acquisition unit, which transforms the amplified electric signals into respective digital signals (i.e., digital data streams). The digital signals in turn are sent to a processor adapted to execute program logic in order to analyze the digital signals to discriminate between any signals emanating from wood-boring insects and those emanating from ambient noise sources. The signal conditioning unit, along with the data acquisition unit and the processor, comprise additional components of the aforementioned system.

In an embodiment, the processor is configured to be coupled to a non-transitory, computer-readable storage medium with program logic for execution by the processor. The program logic includes a logic module executable by the processor for receiving electric signals from the primary and reference sensors, wherein the logic module is configured to provide an automatic insect detection algorithm, which can execute one or more of the following three methods (i.e., steps) to discriminate between potential insect signals and extraneous noise: (1) the comparison of detected primary sensor pulses with pulses from the reference sensor to eliminate pulses produced by external noise; (2) signal discrimination based on acoustic features, including (a) pulse duration, (b) frequency with the maximal amplitude in the pulse frequency spectrum (i.e., main frequency), and (c) frequency with the maximal amplitude in the pulse envelope spectrum (i.e., main envelope frequency); and (3) counting the number of insect-like pulses occurring within a definite time window and making a determination that the tested structure (e.g., wood product) is infested when the number of detected insect pulses for a definite time window exceeds a pre-defined threshold.

In an embodiment, the primary sensor is an accelerometer sensor. In other embodiments, the primary sensor could be a displacement sensor, a capacitor sensor, a velocity transducer, a laser doppler vibrometer, a fiber optical vibrometer, an ultrasonic vibrometer, a geophone, or any other type of the vibration sensor. Regardless of the embodiment, the contact between the primary sensor and the structure can be improved by providing the sensor assembly with a weighted casing or housing.

In an embodiment, the reference sensor is a microphone, or another type of the acoustic sensor. The reference sensor (e.g., microphone) can be configured to be sensitive to ambient noise and insensitive to the vibro-acoustic signals generated by one or more wood boring species in the structure (e.g., wood product). For example, and as indicated above, the reference sensor can be positioned near, but out of contact with, the structure to be tested. By way of further example, the reference sensor can be isolated from the primary sensor by a physical, sound-proof barrier, such as a flexible skirt which surrounds the primary sensor and acoustically insulates it from ambient noise. In another embodiment, the sound-proof barrier can surround the reference sensor, in addition to or in place of surrounding the primary sensor.

In an embodiment, the program logic can be configured to discriminate between noise generated by one or more wood boring species in the structure to be tested and extraneous noise unrelated to the wood boring species by operating N primary sensors, M reference sensors, N+M signal conditioning and acquisition devices to generate N+M signal streams based on input from the N+M primary and reference sensors.

It is an object of the present invention to construct an algorithm that makes an informed decision about whether or not an inspected wood structure is infested.

It is a further object of the present invention to develop vibro-acoustic methods of wood boring insect detection in trees.

It is an additional object of the present invention to provide a tool for fast and reliable tree surveys that will allow for wood boring insect detection, while increasing the insect detection rate significantly.

An object of the present invention is to allow for early detection of wood boring insects as compared with current methods.

Yet another object of the present invention is to provide software for automated insect sound detection that provides high probability of detection with a low false alarm rate.

Future applications may include implementation of the developed system and algorithms for detection of wood boring insects in wood packaging materials and wood products at U.S. ports of entry and development of methods to detect wood boring insects in live trees.

### BRIEF DESCRIPTION OF THE DRAWINGS

For a more complete understanding of the present invention, reference is made to the following detailed description of various embodiments considered in conjunction with the accompanying drawings, in which:

FIG. 1 shows a wood boring invasive species detection system for wood packing materials in accordance with an embodiment of the present invention adapted to test wooden pallets;

FIG. 2 is a schematic diagram of one embodiment of a sensor assembly adapted for use in conjunction with the detection system of FIG. 1;

FIG. 3 shows a bottom view of the sensor assembly shown schematically in FIG. 2;

FIG. 4A shows a wood boring invasive species detection system for live trees in accordance with an embodiment of the present invention;

FIG. 4B shows a bottom view of the system shown in FIG. 4A;

FIG. 5 is a schematic diagram of one embodiment of a sensor assembly adapted for use in conjunction with the detection system of FIG. 4;

FIG. 6 shows an example of structural analysis of an insect vibro-acoustic (pulse in the time domain for ALB larvae in accordance with an embodiment of the present invention, demonstrating that some observed larval feeding sounds can be similar in structure to those observed in previously published research, including short pulses with a fast-rising front edge followed by a “tail” with an exponential decay. In an embodiment of the present invention, the time durations of these pulses are applied as one of the features for insect signal discrimination from noise signal. The time track of the recorded signal is shown by the dashed data line, while the solid data line shows a pulse envelope from the detected larva;

FIG. 7A shows a spectral analysis of an insect pulse in accordance with an embodiment of the present invention. The frequency of the spectral component with the highest amplitude (main signal frequency 4.45 KHz) is used as a feature for insect signal discrimination;

FIG. 7B shows a spectral analysis of an insect pulse envelope in accordance with an embodiment of the present invention. The frequency of the spectral component with the highest amplitude (main envelope frequency 1.1 KHz) is used as a feature for insect signal discrimination; and

FIG. 8 is a flowchart of an insect detection algorithm in accordance with an embodiment of the present invention.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” “coupled” and “uncoupled,” as well as variations of such terms, are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the present invention. Various modifications to the disclosed embodiments will be readily apparent to those skilled in the art, and the generic principles herein can be applied to other embodiments and applications without departing from the disclosed embodiments of the present invention. Thus, embodiments of the present invention are not intended to be limited to the embodiments disclosed herein, but are to be accorded the widest scope consistent with the principles and features disclosed herein. The following detailed description is to be read with reference to the figures, in which like elements, if any, in different figures have like reference numerals. The figures, which are not necessarily to scale, depict selected embodiments and are not intended to limit the scope of embodiments of the present invention. Skilled artisans will recognize the examples provided herein have many useful alternatives that fall within the scope of embodiments of the present invention.

Some embodiments of the invention include a detection system that utilizes one or more vibration and/or acoustic sensors to detect deleterious insects in living trees, felled trees, and/or man-made products such as logs, shaped wood products, and/or wood assemblies such as trusses and wooden shipping pallets. More specifically, embodiments of the present invention relate to systems and methods of signal processing of vibro-acoustic signals from materials of the structure for the purpose of detecting the presence of unwanted insects by acoustic and vibrational means.

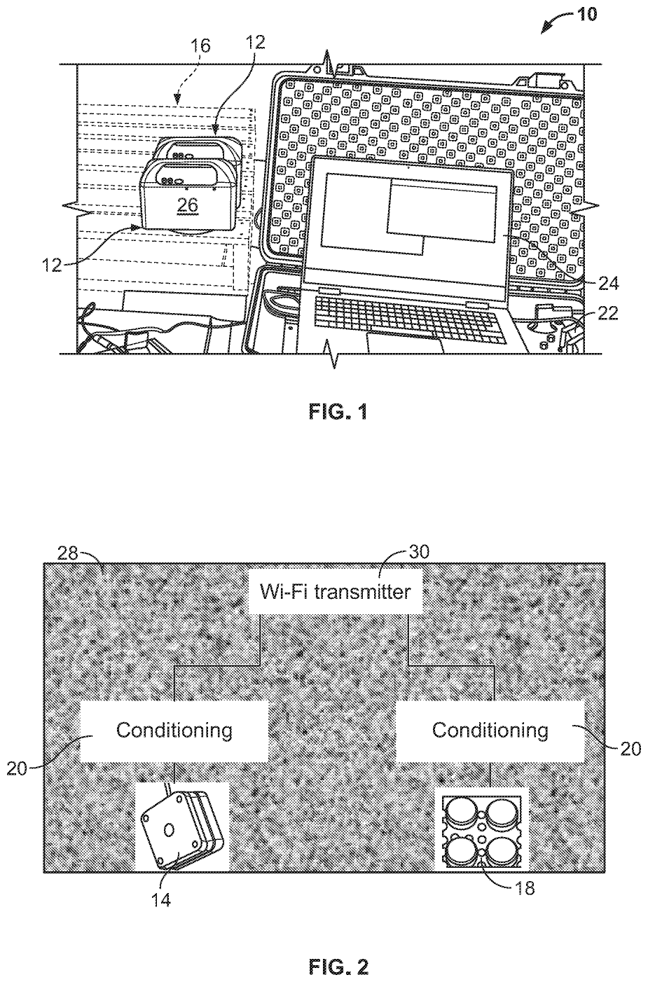

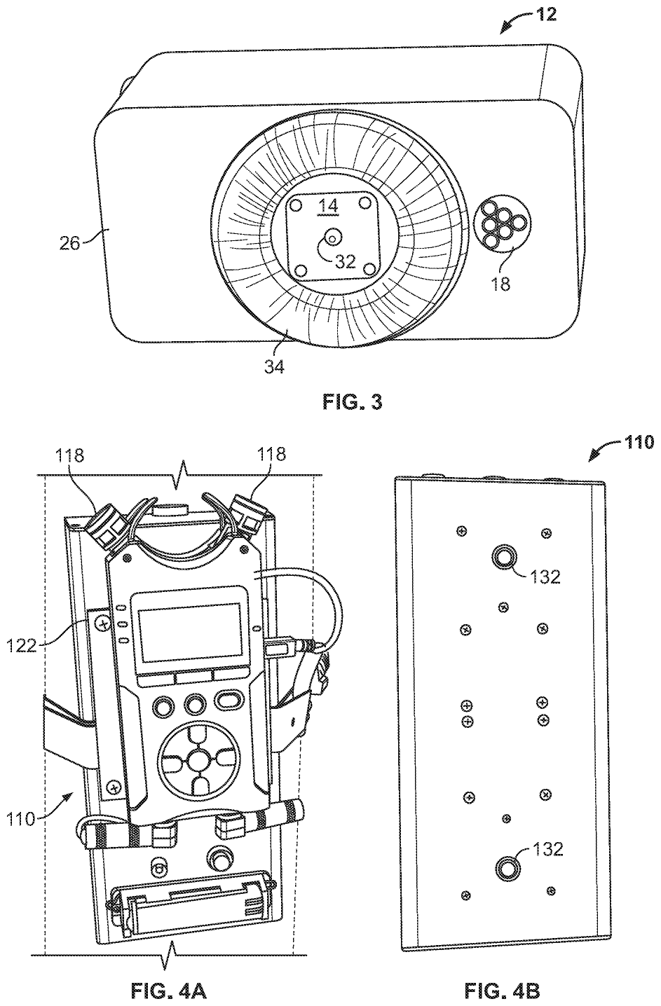

Referring to FIGS. 1-4 in general, and in particular, FIG. 1, a wood boring invasive species detection system 10 is shown in accordance with an embodiment of the present invention. In this embodiment, the wood boring invasive species detection system 10 includes two sensor assemblies 12, 12, each having one or more sensors (see FIGS. 3 and 4).

FIG. 2 shows a schematic of one of the sensor assemblies 12 shown in FIG. 1. As illustrated in FIG. 2, the sensor assembly 12 depicted therein includes a main (i.e., primary) sensor 14 (e.g., an accelerometer), which is configured to be coupled to a wood pallet 16 (shown in phantom), and a reference sensor 18 (e.g., a microphone), which is configured to be uncoupled from the wood pallet 16. In an embodiment, the wood boring invasive species detection system 10 can also include a signal conditioner 20 (see FIGS. 2 and 4). While sensors 14, 18 provide transformation of vibration and acoustic waves, respectively, to respective electrical signal streams, the signal conditioner 20 provides amplification of the electrical signal streams in preparation for transmission of the signal, by wired or wireless connection, to a data acquisition system 22 (see FIG. 1). The data acquisition system 22, in turn, provides transformation of the electrical signal streams to respective digital signal streams to be sent to a processor 24 (e.g., a computer) for signal processing.

In an embodiment, contact between the vibration sensor and the wood surface being tested can be enhanced by housing the sensor assembly 12 in a case 26 which is weighted down by, for instance, lead pellets 28 (see FIG. 2). The use of a weighted housing or case eliminates the need for clamping and/or gluing the sensor assembly 12 to the tested structure by providing enough weight around the sensor assembly 12 to accomplish good sensor to wood coupling, while making the installation of the sensor assembly 12 simple and effortless to an inspector at a port's agricultural facility. In an embodiment, the sensors 14, 18 are wirelessly connected with the data acquisition system 22 using secure WiFi via Wi-Fi transmitter 30, thereby obviating the need for any cable connections and allowing for fast and reliable inspection in warehouses and the like.

FIG. 3 shows the bottom of the sensor assembly 12 with its part of the primary sensor 14 and part of reference sensor 18 being visible. In an embodiment, the primary sensor 14 is an accelerometer sensor having a spherical tip 32 that can grip the tested wood structure (not shown), and a microphone that functions as the reference sensor 18, which is configured to measure ambient acoustic noise. In an embodiment, the acoustic noise signal from the reference sensor 18 can be used for the suppression of the influence of acoustic ambient noise on the wood boring insect detection algorithm.

In an embodiment, the lower surface of sensor assembly 12 can include a soft, sound-proofed skirt 34 that creates an acoustic barrier which decreases the penetration of external sound (i.e., ambient acoustic waves) to the primary sensor 14. In this illustrated embodiment, the skirt 34 surrounds the primary sensor 14.

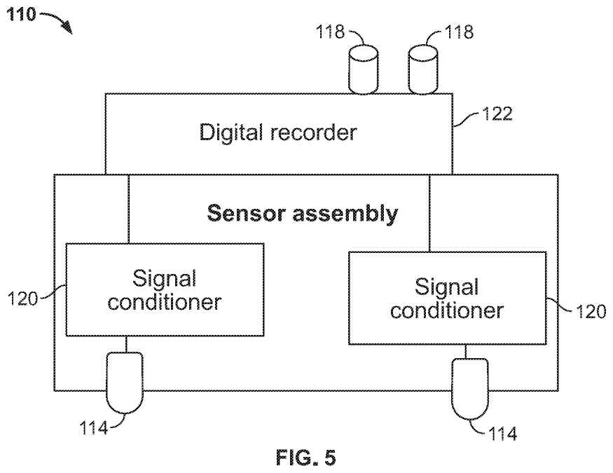

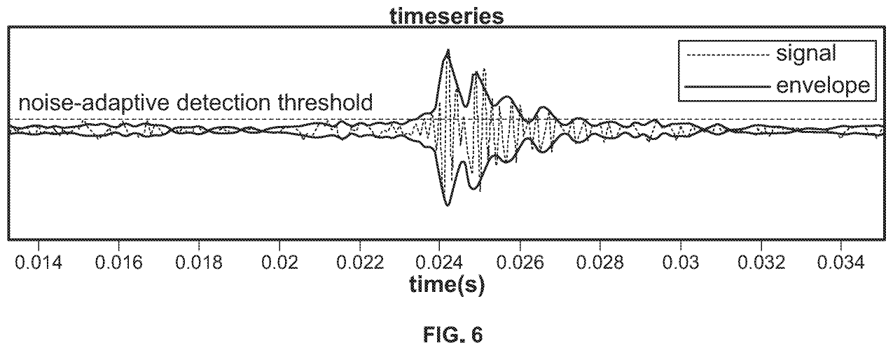

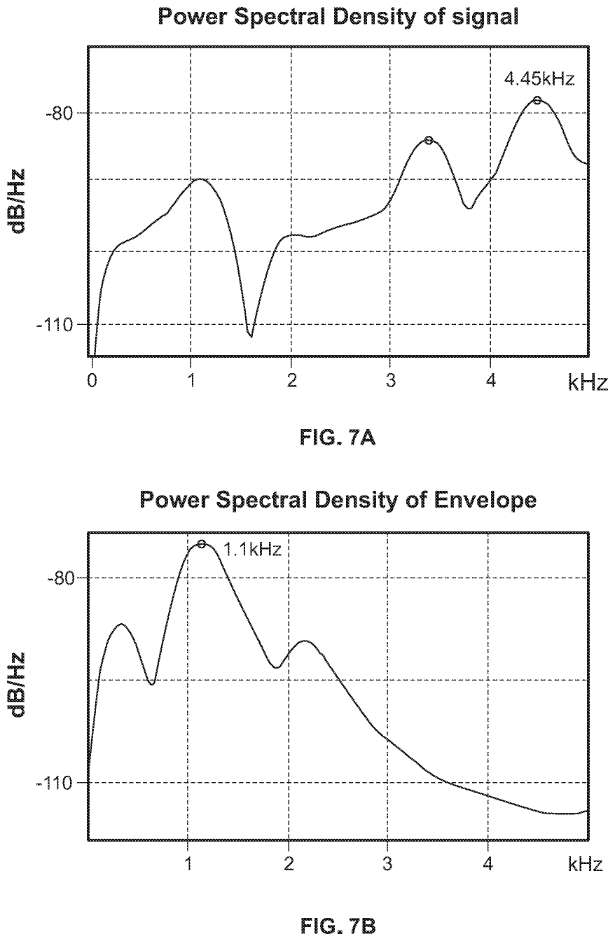

In an alternate embodiment depicted in FIGS. 4 and 5, a wood boring invasive species detection system 110 includes four channels, and part of the system is a portable Wood Boring Recorder (i.e., WoBoR) that is built specifically for simple and fast detection of invasive species in trees. The system 110, which is designed to be mounted to a tree by the tension in a belt (not shown), can be built as a portable, low-cost unit for insect detection. For example, it can use two primary sensors 114, 114 with spherical tips 132, 132; two reference sensors 118, 118; a signal conditioner 120 and a data acquisition system 122 (e.g., a digital recorder) that provides data acquisition and recording of the vibrational/acoustic signals.

Electrical signals from the sensors 114, 114, 118, 118 may be received by the data acquisition system 122 and then can be sent to a processor (not shown), after digitization, for signal processing and analysis. Data processing and analysis of the recorded data is conducted by a non-transitory, computer-readable storage medium with program logic for execution by the processor. The program logic includes a logic module executable by the processor for recorded signals from the primary and reference sensors, wherein the logic module is configured to provide an automatic insect detection algorithm. The system 110 provides high quality and low noise recordings, and real-time data analysis of tree vibrations. Alternatively, the data processing and analysis can be done at a remote location and/or at a later time.

In an embodiment, the signal processing can include one or more steps for the separation of the wood boring insect signals from external noise by way of an automatic detection algorithm which combines three methods to discriminate between potential insect signals and extraneous noise: (1) comparison to a reference sensor, (2) discrimination based on acoustic features, including (a) pulse duration, (b) frequency with the maximal amplitude in the pulse spectrum (main signal frequency), and (c) frequency with the maximal amplitude in the pulse envelope spectrum (main envelope frequency), and (3) discrimination based on the number of detected insect pulses for a definite time window.

In an embodiment of the present invention, the primary sensor pulses are compared with any corresponding reference pulses, and if a pair of pulses took place in close temporal proximity and each had a similar duration, the pulse from the primary sensor is considered as a noise pulse and is not included in further steps, such as the counting of any potential insect-generated pulses.

In an embodiment of the present invention, the main frequency of detected vibro-acoustic pulses, main frequency of the pulse envelopes and duration of the received pulses can be measured, and only signals having main frequency, main envelope frequency and pulse duration close to a previously obtained reference database of insect signals can be chosen for analysis.

Further, in an embodiment, statistical properties of the noise and wood boring insect signals are used to determine the required time of data collection and threshold for decision as to if the tested pallet is infested or not. In some embodiments, the decision that a wood sample is infested is made when the number of detected insect pulses for a definite time window exceeds a pre-defined threshold.

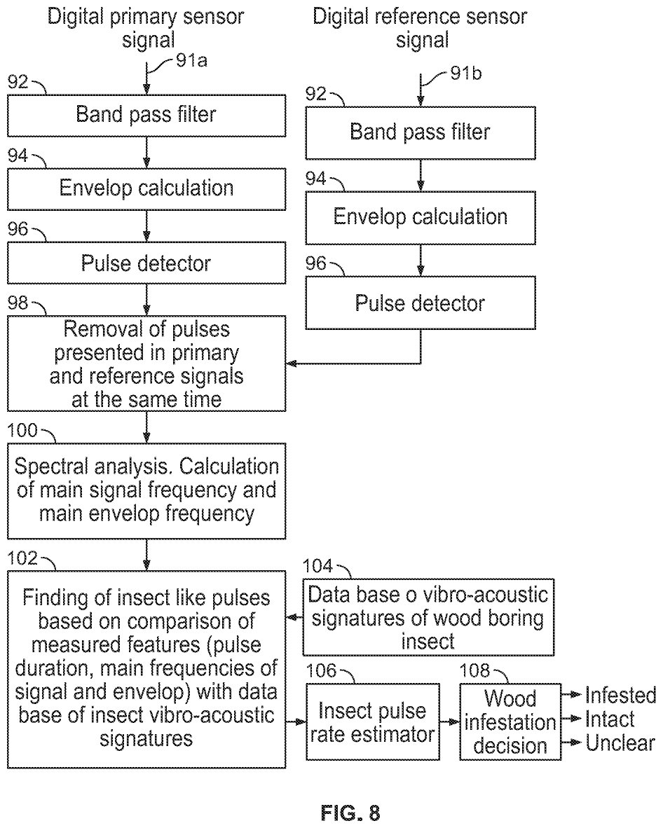

FIG. 8 is an example of an insect detection algorithm flowchart in accordance with an embodiment of the present invention. Analysis of recorded vibrations allows for the extraction of signal features that could ultimately be used for larval classification. These features include the main frequency of the generated pulses, their duration, and main frequency of the pulse envelope. A primary goal of the methods disclosed herein includes preparing a decision as to whether a wood sample under inspection is infested or not. Therefore, an automatic pulse detector and classifier for insect/non-insect pulses are the inner blocks of the algorithm shown in FIG. 8, while the last block of the algorithm is a decision-maker for infestation state.

With continued reference to the insect detection algorithm flowchart of FIG. 8, the methodology of one embodiment of the present invention involves a first step 92 including bandpass filtering in the frequency band of the insect pulses. In the conducted test described in the paper identified in Paragraph 52 below and incorporated by reference herein, the main noise took place in the frequency band below 800 Hz and therefore a high-pass filter with cut-off frequency of 800 Hz was used; although, a bandpass filter with band 800-8000 kHz can provide higher Signal Noise Ratio (SNR). In some embodiments, a second step 94 includes calculating the envelopes of the signal from the primary sensor 91a and/or reference sensor 91b. One possible method of achieving this is via the application of a Hilbert Transform operation.

A further embodiment of the present invention includes a third step 96, where a pulse detector finds all the pulses with an envelope greater than the detection threshold and estimates the parameters of every i^{th} pulse, including start time tStartᵢ, end time tEndᵢ and duration

Still further embodiments of the present invention involve a fourth step 98, where detected pulses are compared with noise signal to noise suppression. The rejection is done for pulses where timing coincides with pulses found in a reference channel. In some embodiments, the decision on time coincidence can take into account possible pulse propagation delay Δₘₐₓ between the primary and reference sensors. The idea is that pulse start/end times in the primary sensor may occur earlier or later than in the reference sensor by Δₘₐₓ=R/cₘᵢₙ, where cₘᵢₙ is a minimal possible sound propagation speed (which is the speed of sound in air of 343 m/s), and R is the distance between the sensors.

Other embodiments of the present invention involve a fifth step 100, where a spectral analysis provides spectra of signal sₓ(f) and spectra of envelope sₑ(f) for every pulse detected by steps 1-4 as described hereinabove, while yet other embodiments include a sixth step 102 where the developed algorithm finds the peaks in spectra and estimate main frequency of signal fₒᵢ, and main frequency of envelope f_{mod i} for every i^{th} detected pulse.

Additional embodiments of the present invention involve a sixth step 102, including pulse discrimination based on pulse duration and spectral features where every pulse is analyzed individually and the pulse is classified as “insect” if the main signal frequency, envelope frequency and duration are in the limits established from a pre-compiled database 104 of vibro-acoustic signatures from one or more wood boring insects.

Yet another embodiment of the present invention involves a seventh step 106, where the number of insect-like pulses is counted within a definite time window and the decision that a wood sample is infested is made when the number of detected insect pulses for a definite time window exceeds a pre-defined threshold. An optional eighth step 108 involves providing an indicator of the product under test being infested, intact, or unclear.

Although one or more of the earlier-described method operations can include a specific or defined order, it should be understood that other housekeeping operations can be performed in between operations, or operations can be adjusted so that they occur at slightly different times, or can be distributed in a system which allows the occurrence of the processing operations at various intervals associated with the processing, as long as the processing of the overlay operations are performed in the desired way. Further, it is understood that one or more of the earlier-described method operations can be performed out of order, or not performed, skipped, and/or delayed.

Additional details on the present system and its associated methods of detecting wood boring insects can be found in the publication by Alexander Sutin et al., titled “Towards an Automated Acoustic Detection Algorithm for Wood-Boring Beetle Larvae (Coleoptera: Cerambycidae and Buprestidae),” Journal of Economic Entomology, Vol. 112, No. 3, May 22, 2019, pp. 1327-1336, <URL: https://academic.oup.com/jee/article/112/3/1327/5316748><DOI: 10.1093/jee/toz016>, the entire disclosure of which publication is incorporated herein by reference in its entirety and made part of the present disclosure.

It will be appreciated by those skilled in the art that while the present invention has been described above in connection with particular embodiments and examples, the present invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the present invention are set forth in the following claims.

1. A system for detecting wood boring insects in a structure, said system comprising:
a sensor assembly adapted to be positioned on the structure, said sensor assembly including a primary sensor adapted to be positioned in contact with the structure and configured to generate first electric signals in response to detected vibro-acoustic signals emanating internally and/or externally of the structure, and a reference sensor adapted to be positioned out of contact with the structure and configured to generate second electric signals in response to detected ambient noise signals emanating externally of the structure;
a signal conditioning unit configured to receive said first and second electric signals from said primary sensor and said reference sensor, respectively, said signal conditioning unit functioning to amplify said first and second electric signals;
a data acquisition unit configured to receive, from said signal conditioning unit, the amplified electric signals corresponding to said first electric signals and the amplified electric signals corresponding to said second electric signals, said data acquisition unit functioning to transform said amplified electric signals corresponding to said first and second electric signals into a first stream of digital signals and a second stream of digital signals; and
a processor configured to be coupled to a non-transitory, computer-readable storage medium which has stored thereon program logic including a logic module executable by said processor to receive said first and second streams of digital signals, said logic module being configured to analyze said first and second streams of digital signals to discriminate between those signals emanating from wood boring insects and those signals emanating from ambient noise sources.

2. The system of claim 1, wherein said primary sensor includes a vibrational sensor.

3. The sensor of claim 2, wherein said vibrational sensor is selected from the group consisting of: accelerometer sensors, displacement transducers, velocity transducers, laser doppler vibrometers, fiber optical vibrometers, laser vibrometers, a piezo sensor, geophones and sensors adapted to detect vibration.

4. The system of claim 2, wherein said primary sensor comprises an accelerometer having a spherical tip.

5. The system of claim 1, wherein said reference sensor includes a microphone.

6. The system of claim 1, wherein said reference sensor is configured to be sensitive to ambient noise and not sensitive to vibro-acoustic signals emanating internally of the structure.

7. The system of claim 1, wherein said sensor assembly further comprises a sound-proofing unit for acoustically insulating at least said primary sensor from ambient noise signals emanating externally of the structure.

8. The system of claim 7, wherein said sound-proofing unit includes a skirt-like barrier surrounding at least said primary sensor.

9. The system of claim 1, wherein said sensor assembly further includes weighted elements, whereby contact between said primary sensor and the structure is enhanced.

10. The system of claim 9, wherein said weighted elements include lead pellets contained within a housing for said sensor assembly.

11. The system of claim 1, wherein said program logic is configured to identify insect-produced vibro-acoustic signals based on one or more signal features thereof by executing the following steps via said processor:
a) high-pass filtering said first and second streams of digital signals to suppress any low frequency ambient noise;
b) calculating signal envelopes from said first and second streams of digital signals;
c) detecting any pulses contained in said signal envelopes with an envelope greater than a chosen detection threshold;
d) estimating the duration of every i^{th} pulse, determining a starting time tStartᵢ and an end at time tEndᵢ with a duration τₗ;
e) providing a signal spectra sₓ(f) and envelope spectra sₑ(f) for every detected pulse;
f) estimating an amplitude, a main signal frequency fₒᵢ, and a main envelope frequency f_{mod i} for every i^{th} detected pulse; and
g) performing a pulse classification of said detected pulses based on calculated features, including pulse duration, main signal frequency and main envelope frequency, to provide an output classification as insect-originating, non-insect originating, or inconclusive.

12. A method for detecting wood boring insects in a structure, said method comprises the steps of:
generating first electric signals in response to vibro-acoustic signals emanating internally and/or externally of the structure;
generating second electric signals in response to detected ambient noise signals emanating externally of the structure;
amplifying said first and second electric signals;
transforming said amplified electric signals corresponding to said first electric signals into a first stream of digital signals;
transforming said amplified electric signals of said second electric signals into a second stream of digital signals; and
analyzing said first and second streams of digital signals so as to discriminate between those signals emanating from wood boring insects, and those signals emanating from ambient noise.

13. The method of claim 12, wherein said analyzing step further includes the steps of:
i. high-pass filtering said first and second streams of digital signals;
ii. calculating signal envelopes from said first and second streams of digital signals to generate primary envelopes and reference envelopes, respectively;
iii. detecting all pulses of said primary and reference envelopes with an envelope greater than a chosen detection threshold;
iv. estimating one or more parameters of every i^{th} pulse, including a start at time tStartᵢ and an end at time tEndᵢ with a duration τₗ;
v. rejecting as extraneous noise any pulses of said primary envelopes having tStartᵢ and vi corresponding to those of said pulses of said reference envelopes.

14. The method of claim 12, further comprising the steps of: counting a quantity of pulses of said signals emanating from wood boring insects; and classifying the structure as infested when said quantity of pulses exceeds a pre-defined threshold for a definite time window.

15. The method of claim 12, wherein said first electric signals are generated in response to vibro-acoustic signals emanating solely internally of the structure.

16. The method of claim 12, further comprising the step of acoustically insulating at least said primary sensor from signals emanating from ambient noise sources.

17. A sensor assembly adapted for detecting wood boring insects in a structure, comprising:
a housing;
a primary sensor positioned on said housing so as to be in contact with the structure when the sensor assembly is placed thereon, said primary sensor configured to generate first electric signals in response to detected vibro-acoustic signals emanating internally and/or externally of the structure;
a reference sensor positioned on said housing so as to be out of contact with the structure when said sensor assembly is placed thereon, said reference sensor configured to generate second electric signals in response to detected ambient noise signals emanating externally of the structure;
weighted elements positioned in said housing, whereby contact between said primary sensor and the structure is enhanced; and
a sound-proofing unit for acoustically insulating at least said primary sensor from ambient noise signals emanating externally of the structure.

18. The sensor assembly of claim 17, wherein said reference sensor is a microphone.

19. The sensor assembly of claim 17, wherein said reference sensor is configured to be sensitive to ambient noise and not sensitive to vibro-acoustic signals emanating internally of the structure.

20. The sensor assembly of claim 17, wherein said primary sensor includes a vibrational sensor.

21. The sensor assembly of claim 20, wherein said vibrational sensor is selected from the group consisting of: accelerometer sensors, displacement transducers, velocity transducers, laser doppler vibrometers, fiber optical vibrometers, laser vibrometers, piezo sensors, geophones and sensors adapted to detect vibration.

22. The sensor assembly of claim 17, wherein said primary sensor comprises an accelerometer having a spherical tip.

23. The sensor assembly of claim 17, wherein said sound-proofing unit includes a skirt-like barrier surrounding at least said primary sensor.
